(19) United States
(12) Patent Application Publication
(10) Pub. No.: US 2007/0120769 A1
(43) Pub. Date: May 31, 2007

(54) Plasma display apparatus and method of driving the same

(75) Inventor: Seonghak Moon, Seoul (KR)

Correspondence Address: KED & ASSOCIATES, LLP, P.O. Box 221200, Chantilly, VA, 20153-1200, US

(73) Assignee: LG Electronics Inc.

(21) Appl. No.: 11/604,772

(22) Filed: Nov. 28, 2006

(30) Foreign Application Priority Data
Nov. 28, 2005 (KR) 10-2005-0114464

(51) Int. Cl. G09G 3/28

(52) U.S. Cl. 345/60

(57) ABSTRACT

A plasma display apparatus and a method of driving the same are disclosed. The plasma display apparatus includes a plasma display panel, a panel driver, a subfield mapping unit, and a controller. The plasma display panel, on which an image is displayed through a video signal input from the outside, includes a plurality of electrodes. The panel driver drives the plurality of electrodes. The subfield mapping unit controls the number of subfields in accordance with the amount of data load of the video signal. The controller sets the subfield mapping unit to the number of subfields corresponding to a vertical frequency of the video signal, and sets the panel driver to a sustain pulse frequency proportional to the vertical frequency.

This Nonprovisional application claims priority under 35 U.S.C. §119(a) on patent application No. 10-2005-0114464 filed in Korea on Nov. 28, 2005, the entire contents of which are hereby incorporated by reference.

### BACKGROUND OF THE INVENTION

1. Field of the Invention

This document relates to a plasma display apparatus and a method of driving the same.

2. Description of the Background Art

A plasma display panel has the structure in which barrier ribs formed between a front panel and a rear panel forms unit discharge cell or discharge cells. Each discharge cell is filled with an inert gas containing a main discharge gas such as neon (Ne), helium (He) and a mixture of Ne and He, and a small amount of xenon (Xe). When the plasma display panel is discharged by a high frequency voltage, the inert gas generates vacuum ultraviolet rays, which thereby cause phosphors formed between the barrier ribs to emit light, thus displaying an image.

FIG. 1 illustrates the structure of a related art plasma display panel.

As illustrated in FIG. 1, the plasma display panel includes a front panel 100 and a rear panel 110 which are coupled in parallel to oppose to each other at a given distance therebetween. The front panel 100 includes a front substrate 101 being a display surface which an image is displayed. The rear panel 110 includes a rear substrate 111 constituting a rear surface. A plurality of scan electrodes 102 and a plurality of sustain electrodes 103 are formed in pairs on the front substrate 101 to form a plurality of maintenance electrode pairs. A plurality of address electrodes 113 are formed on the rear substrate 111 to intersect the plurality of maintenance electrode pairs.

The scan electrode 102 and the sustain electrode 103 each include transparent electrodes 102a and 103a made of a transparent indium-tin-oxide (ITO) material, and bus electrodes 102b and 103b made of a metal material. The scan electrode 102 and the sustain electrode 103 generate a mutual discharge therebetween in one discharge cell and maintain light-emissions of discharge cells.

The scan electrode 102 and the sustain electrode 103 are covered with one or more upper dielectric layers 104 for limiting a discharge current and providing insulation between the maintenance electrode pairs. A protective layer 105 with a deposit of MgO is formed on an upper surface of the upper dielectric layer 104 to facilitate discharge conditions.

A plurality of stripe-type (or well-type) barrier ribs 112 are arranged in parallel on the rear substrate 111 of the rear panel 110 to form a plurality of discharge spaces (i.e., a plurality of discharge cells). The plurality of address electrodes 113 for performing an address discharge to generate vacuum ultraviolet rays are arranged in parallel to the barrier ribs 112.

An upper surface of the rear substrate 111 is coated with Red (R), green (G) and blue (B) phosphors 114 for emitting visible light for an image display when an address discharge is performed. A lower dielectric layer 115 is formed between the address electrodes 113 and the phosphors 114 to protect the address electrodes 113.

FIG. 2 illustrates one example of a driving waveform according to a method of driving the related art plasma display panel.

As illustrated in FIG. 2, the plasma display panel is driven by dividing each of subfields into a reset period for initializing all discharge cells, an address period for selecting cells to be discharged, a sustain period for discharge maintenance of the selected cells, and an erase period for erasing wall charges accumulated inside the discharged cells.

The reset period is further divided into a setup period and a set-down period. During the setup period, a rising waveform (Ramp-up) is simultaneously supplied to all scan electrodes Y, thereby generating a weak dark discharge within the discharge cells of the whole screen. This results in the accumulation of wall charges of a positive polarity on the address electrodes and the sustain electrodes, and the accumulation of wall charges of a negative polarity on the scan electrodes.

During the set-down period, a falling waveform (Ramp-down) which falls from a positive voltage lower than the highest voltage of the rising waveform (Ramp-up) to a given voltage level lower than a ground level voltage is supplied to the scan electrodes Y, thereby generating a weak erase discharge within the discharge cells. Furthermore, the remaining wall charges are uniform inside the cells to the extent that the address discharge can be stably performed.

During the address period, scan pulses (Scan) of a negative polarity are consecutively supplied to the scan electrodes Y and, at the same time, a data pulse (Date) of a positive polarity synchronized with the scan pulse (Scan) is selectively supplied to the address electrodes X. As the voltage difference between the scan pulse (Scan) and the data pulse (Date) is added to the wall voltage generated during the reset period, the address discharge occurs within the discharge cells to which the data pulse (Date) is supplied.

Wall charges are formed inside the discharge cells selected by performing the address discharge such that when a sustain voltage Vs is supplied a discharge occurs. A positive voltage Vz is supplied to the sustain electrode Z during the set-down period and the address period so that an erroneous discharge does not occur between the sustain electrode Z and the scan electrode Y by reducing the voltage difference between the sustain electrode Z and the scan electrode Y.

During the sustain period, a sustain pulse (Sus) is alternately supplied to the scan electrode Y and the sustain electrode Z. As the wall voltage within the cells selected by performing the address discharge is added to the sustain pulse (Sus), every time the sustain pulse (Sus) is supplied, a sustain discharge, i.e., a display discharge is generated between the scan electrode Y and the sustain electrode Z.

Finally, during the erase period (i.e., after the sustain discharge is completed), an erase waveform (Ramp-ers) having a small pulse width and a low voltage level is supplied to the sustain electrodes Z to erase the remaining wall charges within all the discharge cells.

The following is a detailed description of a method for achieving a gray level of an image displayed on the related art plasma display panel thus driven, with reference to FIG. 3.

FIG. 3 illustrates a method for achieving a gray level of an image displayed on the related art plasma display panel.

As illustrated in FIG. 3, a frame in the plasma display panel is divided into several subfields having a different number of emission times. Each subfield is subdivided into a reset period for initializing all the cells, an address period for selecting cells to be discharged, and a sustain period for representing a gray level in accordance with the number of discharge times. For example, if an image with 256-level gray level is to be displayed, a frame period (for example, 16.67 ms) equal to 1/60 second is divided into eight subfields SF1 to SF8. Each of the eight subfields SF1 to SF8 is subdivided into a reset period, an address period and a sustain period.

The duration of the reset period in a subfield is equal to the duration of the reset periods in the remaining subfields. The duration of the address period in a subfield is equal to the duration of the address periods in the remaining subfields. The voltage difference between the address electrode and the transparent electrode, which is the scan electrode, generates the address discharge for selecting the cells to be discharged.

The sustain period increases in a ratio of 2ⁿ (where, n=0, 1, 2, 3, 4, 5, 6, 7) in each subfield. Since the sustain period varies from one subfield to the next subfield, a specific gray level is achieved by controlling the sustain period which are to be used for discharging each of the selected cells, i.e., the number of sustain discharge times that are realized in each of the discharge cells.

When a specific vertical frequency (for example, a vertical frequency of 60 Hz) is input to a related art plasma display apparatus, a timing process or a subfield mapping process is performed in response to the specific vertical frequency. If an input vertical frequency is modified (for example, if a vertical frequency of 70 Hz is input) in the middle of the image display, the time allotted for the sustain period decreases because a period of the vertical frequency becomes shorter. This results in a reduction in the number of sustain pulses and a reduction in luminance.

### SUMMARY OF THE INVENTION

In one aspect, a plasma display apparatus comprises a plasma display panel, on which an image is displayed through a video signal input from the outside, including a plurality of electrodes, a panel driver that drives the plurality of electrodes of the plasma display panel, a subfield mapping unit that controls the number of subfields in accordance with the amount of data load of the video signal, and a controller that sets the subfield mapping unit to the number of subfields corresponding to a vertical frequency of the video signal, and sets the panel driver to a sustain pulse frequency proportional to the vertical frequency.

The controller may include a detector that detects the vertical frequency, and a comparator that selects an area and a mode corresponding to the detected vertical frequency from a plurality of areas and a plurality of modes which are previously set.

The comparator may send a control signal including the number of subfields and a sustain pulse frequency corresponding to the selected area and the selected mode to the panel driver.

The sustain pulse frequency in at least one subfield may be different from a sustain pulse frequency in the remaining subfields.

The sustain pulse frequency may be two or more in at least one subfield of a frame.

The sustain pulse frequency may be linearly set between a minimum value and a maximum value of the vertical frequency.

The plasma display panel may include a scan electrode, a sustain electrode, and an address electrode.

The plasma display panel may include at least one of a scan electrode, a sustain electrode, and an address electrode.

The panel driver may include a data driver driving an address electrode, a scan driver driving a scan electrode, and a sustain driver driving a sustain electrode.

As the vertical frequency of the video signal increases, the controller may increase an average frequency of sustain pulses supplied during a plurality of subfields of one frame.

In another aspect, a method of driving a plasma display apparatus, comprises storing the number of subfields corresponding to a vertical frequency of a video signal and a sustain pulse frequency proportional to the vertical frequency in a predetermined area and a predetermined mode, detecting the vertical frequency of the video signal, selecting an area and a mode corresponding to the detected vertical frequency from a plurality of areas and a plurality of modes which are previously set, and setting the number of subfields and a sustain pulse frequency corresponding to the selected area and the selected mode.

The setting of the number of subfields and the sustain pulse frequency may include sending a control signal including the number of subfields and the sustain pulse frequency corresponding to the selected area and the selected mode.

The sustain pulse frequency in at least one subfield may be different from a sustain pulse frequency in the remaining subfields.

The sustain pulse frequency may be two or more in at least one subfield of a frame.

In the storing of the number of subfields and the sustain pulse frequency, the sustain pulse frequency may be linearly set between a minimum value and a maximum value of the vertical frequency.

As the vertical frequency of the video signal increases, an average frequency of sustain pulses supplied during a plurality of subfields of one frame may increase.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention.

FIG. 1 illustrates the structure of a related art plasma display panel;

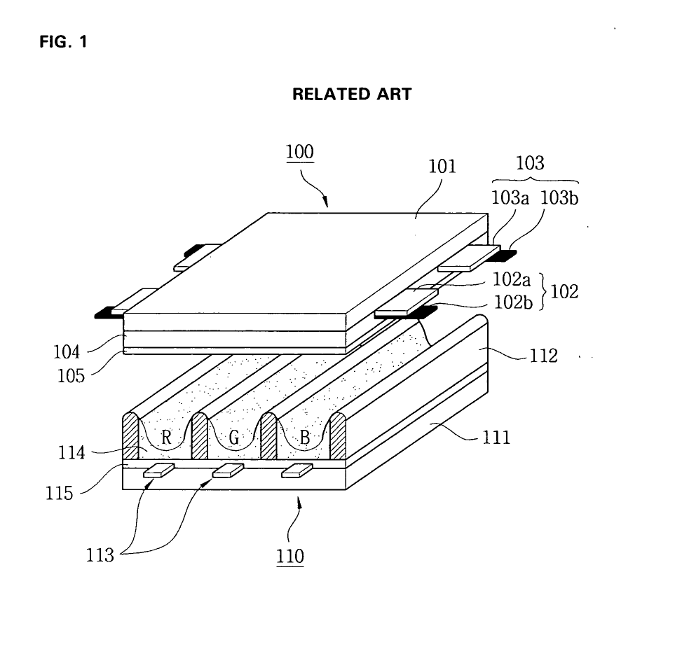

FIG. 2 illustrates one example of a driving waveform according to a method of driving the related art plasma display panel;

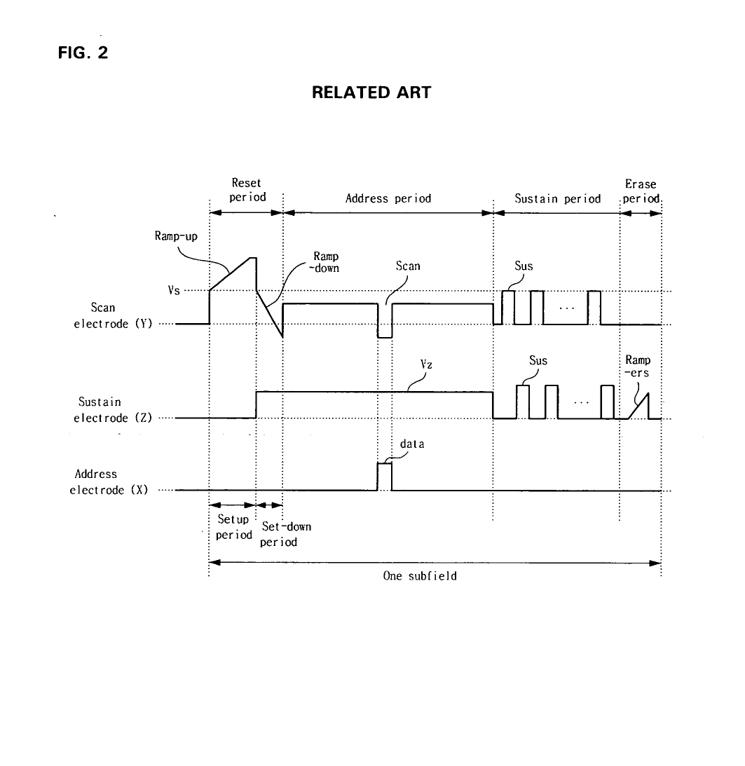

FIG. 3 illustrates a method for achieving a gray level of an image displayed on the related art plasma display panel;

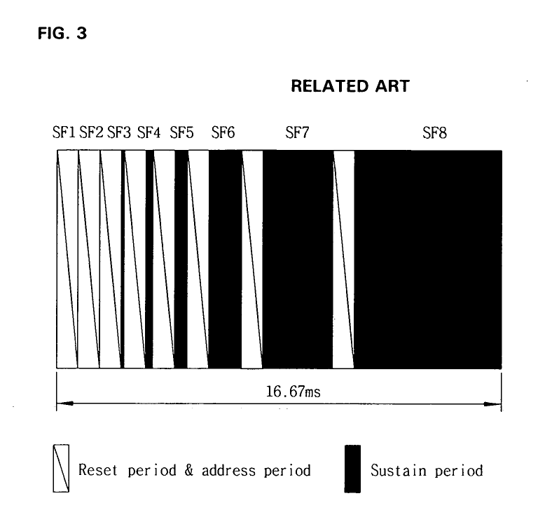

FIG. 4 is a block diagram of a plasma display apparatus according to an embodiment;

FIG. 5 illustrates an increase in a sustain pulse according to an increase in a vertical frequency input to the plasma display apparatus of FIG. 4; and

FIG. 6 is a flow chart of a method of driving the plasma display apparatus according to the embodiment.

### DETAILED DESCRIPTION OF PREFERRED EMBODIMENTS

Hereinafter, exemplary embodiments of the present invention will be described in detail with reference to the attached drawings.

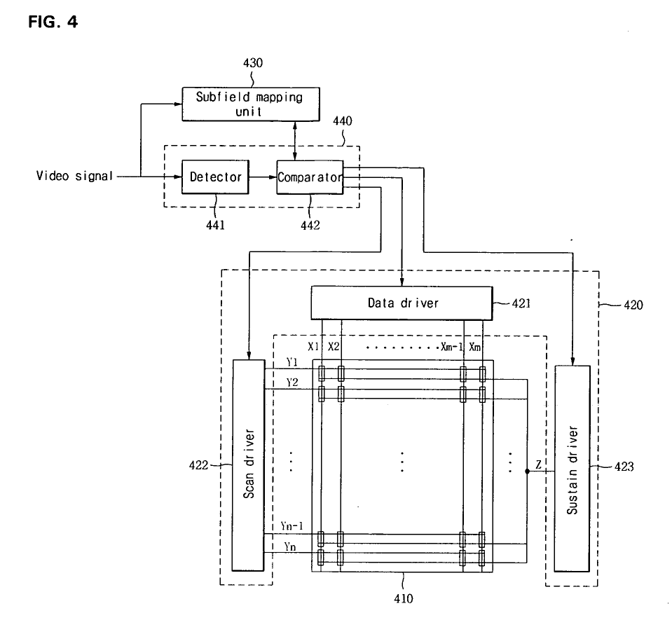

FIG. 4 is a block diagram of a plasma display apparatus according to an embodiment.

As illustrated in FIG. 4, the plasma display apparatus according to the embodiment includes a plasma display panel 410, a panel driver 420, a subfield mapping unit 430, and a controller 440. The panel driver 420 includes a data driver 421, a scan driver 422, and a sustain driver 423. The controller 440 includes a detector 441 and a comparator 442.

An image is displayed on the plasma display panel 410 by data-processing a video signal input from the outside. Although FIG. 4 illustrates the plasma display panel 410 including scan electrodes Y1 to Yn, sustain electrodes Z, and address electrodes X1 to Xm, the plasma display panel 410 may include at least one of the scan electrodes Y1 to Yn, the sustain electrodes Z, and the address electrodes X1 to Xm. The plasma display panel 410 applicable to the embodiment has to only include a plurality of electrodes supplied with a driving voltage.

The panel driver 420 drives the plurality of electrodes by supplying a predetermined driving voltage to the plurality of electrodes formed in the plasma display panel 410.

The data driver 421 receives data mapped for each subfield by a subfield mapping circuit (not shown) after being inverse-gamma corrected and error-diffused through an inverse gamma correction circuit (not shown) and an error diffusion circuit (not shown), or the like. The data driver 421 samples and latches the mapped data under the control of the controller 440, and then supplies the data to the address electrodes X1 to Xm.

The scan driver 422 drives the scan electrodes Y1 to Yn of the plasma display panel 410. For example, a sustain pulse having a sustain voltage Vs is supplied to the scan electrodes Y1 to Yn during a sustain period which follows an address period.

The sustain driver 423 drives the sustain electrodes Z of the plasma display panel 410. For example, a sustain pulse having a sustain voltage Vs is supplied to the sustain electrodes Z during the sustain period.

The scan driver 422 and the sustain driver 423 each supply the sustain pulses to the plurality of electrodes of the plasma display panel 410 during each subfield, thereby driving the plasma display panel 410.

Since the panel driver 420 is one example of the plasma display apparatus according to the embodiment, the panel driver 420 can drive the plurality of electrodes despite of using a different method such as a single sustain method.

The subfield mapping unit 430 controls the number of subfields in accordance with the amount of data load of the video signal. The controller 440 supplies the data mapped in accordance with a subfield pattern, which is previously set by the subfield mapping unit 430, to the data driver 421, and then controls the number of subfields.

The controller 440 sets the subfield mapping unit 430 to the number of subfields corresponding to a vertical frequency, and sets the panel driver 420 to a sustain pulse frequency proportional to the vertical frequency. As a vertical frequency of the input video signal increases, the controller 440 increases an average frequency of sustain pulses supplied during a plurality of subfields of one frame.

In other words, the detector 441 detects an input vertical frequency. Then, a comparator 442 selects an area and a mode corresponding to the detected vertical frequency from a plurality of areas and a plurality of modes which are previously set.

More specifically, an area 1, an area 2, an area 3 and an area 4 are previously set to 50-59 Hz, 60-70 Hz, 71-90 Hz, and 91-120 Hz, respectively. A vertical frequency within the range of the areas 1 and 2 is set to a mode 1, and a vertical frequency within the range of the areas 3 and 4 is set to a mode 2.

If the detected vertical frequency is within the range of the areas 1 and 2, the comparator 442 sends a control signal including the number of subfields and a sustain pulse frequency corresponding to the mode 1 to the panel driver 420. If the detected vertical frequency is within the range of the areas 3 and 4, the comparator 442 sends a control signal including the number of subfields and a sustain pulse frequency corresponding to the mode 2 to the panel driver 420.

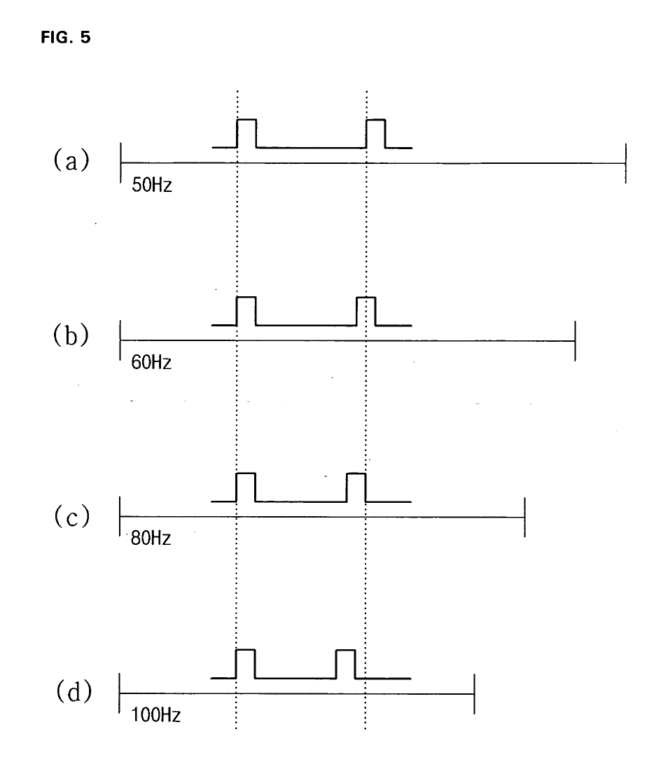

The basic for setting the number of subfields and a sustain pulse frequency corresponding to the vertical frequency will be described with reference to FIG. 5.

The range of the area and the range of the mode may be set differently, and may be further subdivided. The vertical frequency may be divided into a vertical frequency which is frequently used and a vertical frequency which is not frequently used, and then the area and the mode may be set.

A sustain pulse frequency in at least one subfield is different from a sustain pulse frequency in the remaining subfields. Further, different sustain pulse frequencies are applied in the same subfield, and the same subfield includes one or more sustain pulse frequencies.

The sustain pulse frequency in each subfield may be different from one another. Further, different sustain pulse frequencies may be set in the same subfield.

A minimum value and a maximum value of the input vertical frequency are set. Then, the sustain pulse frequency may be linearly set between the minimum value and the maximum value of the input vertical frequency.

FIG. 5 illustrates an increase in a sustain pulse according to an increase in a vertical frequency input to the plasma display apparatus of FIG. 4.

(a), (b), (c) and (d) of FIG. 5 illustrate a period when a vertical frequency is set to 50 Hz, 60 Hz, 80 Hz and 100 Hz, respectively. As the vertical frequency increases, a period capable of displaying one frame decreases. Therefore, the number of sustain pulses decreases under condition of the same sustain pulse frequency.

Accordingly, as illustrated in FIG. 5, the number of sustain pulses generated during one period of the vertical frequency is maintained constantly by increasing the sustain pulse frequency while increasing the vertical frequency. As a result, luminance of the plasma display apparatus is maintained constantly.

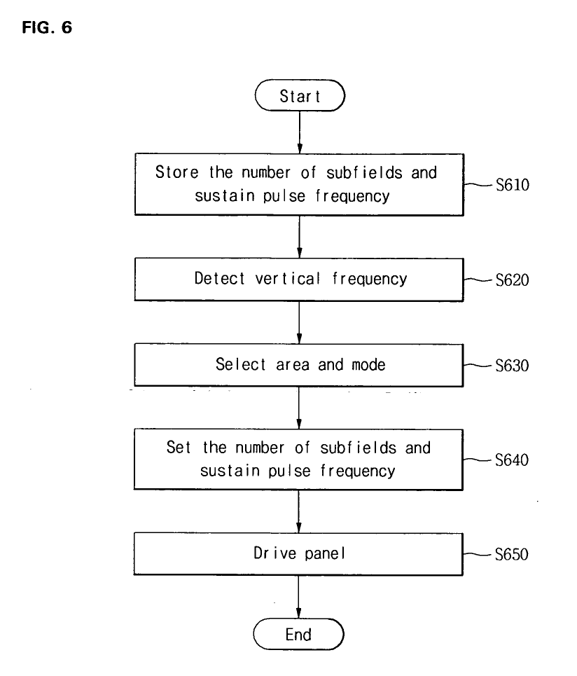

FIG. 6 is a flow chart of a method of driving the plasma display apparatus according to the embodiment.

As illustrated in FIG. 6, the number of subfields corresponding to an input vertical frequency and a sustain pulse frequency proportional to the vertical frequency are stored in a predetermined area and a predetermined mode in step S610. For example, an area 1, an area 2, an area 3 and an area 4 are previously set to 50-59 Hz, 60-70 Hz, 71-90 Hz, and 91-120 Hz, respectively. A vertical frequency within the range of the areas 1 and 2 stores the number of subfields and a sustain pulse frequency corresponding to a mode 1. Further, a vertical frequency within the range of the areas 3 and 4 stores the number of subfields and a sustain pulse frequency corresponding to a mode 2. As the vertical frequency of the input video signal increases, an average frequency of the sustain pulses supplied during the plurality of subfields of one frame increases.

The detector 441 detects the input vertical frequency in step S620. The comparator 442 selects the area, to which the detected vertical frequency belongs, from the plurality of areas that are previously set, and then selects the mode corresponding to the selected area in step S630. The number of subfields and a sustain pulse frequency corresponding to the selected mode are set in step S630. The comparator 442 sets the subfield mapping unit 430 to the set number of subfields, and the comparator 442 sends a control signal to the panel driver 420 so as to set the panel driver 420 to the set sustain pulse frequency. In other words, the comparator 442 sends the control signal to the panel driver 420 so as to control the panel driver 420 using the set number of subfields and the set sustain pulse frequency, thereby driving the plasma display panel 410 in step S650.

In step S640, if the detected vertical frequency is within the range of the areas 1 and 2, the comparator 442 sends a control signal including the number of subfields and a sustain pulse frequency corresponding to the mode 1 to the panel driver 420. If the detected vertical frequency is within the range of the areas 3 and 4, the comparator 442 sends a control signal including the number of subfields and a sustain pulse frequency corresponding to the mode 2 to the panel driver 420.

A sustain pulse frequency in at least one subfield is different from a sustain pulse frequency in the remaining subfields. Further, different sustain pulse frequencies are applied in the same subfield, and the same subfield includes one or more sustain pulse frequencies.

The sustain pulse frequency in each subfield may be different from one another. Further, different sustain pulse frequencies may be set in the same subfield.

In step S610, a minimum value and a maximum value of the vertical frequency are set. Then, the sustain pulse frequency may be linearly set between the minimum value and the maximum value of the vertical frequency.

As described above, luminance of the screen is constantly maintained irrespective of charges in the vertical frequencies input when driving the plasma display apparatus.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112 (6).

What is claimed is:

1. A plasma display apparatus comprising:
a plasma display panel, on which an image is displayed through a video signal input from the outside, including a plurality of electrodes;
a panel driver that drives the plurality of electrodes of the plasma display panel;
a subfield mapping unit that controls the number of subfields in accordance with the amount of data load of the video signal; and
a controller that sets the subfield mapping unit to the number of subfields corresponding to a vertical frequency of the video signal, and sets the panel driver to a sustain pulse frequency proportional to the vertical frequency.

2. The plasma display apparatus of claim 1, wherein the controller includes
a detector that detects the vertical frequency, and
a comparator that selects an area and a mode corresponding to the detected vertical frequency from a plurality of areas and a plurality of modes which are previously set.

3. The plasma display apparatus of claim 2, wherein the comparator sends a control signal including the number of subfields and a sustain pulse frequency corresponding to the selected area and the selected mode to the panel driver.

4. The plasma display apparatus of claim 1, wherein the sustain pulse frequency in at least one subfield is different from a sustain pulse frequency in the remaining subfields.

5. The plasma display apparatus of claim 1, wherein the sustain pulse frequency is two or more in at least one subfield of a frame.

6. The plasma display apparatus of claim 1, wherein the sustain pulse frequency is linearly set between a minimum value and a maximum value of the vertical frequency.

7. The plasma display apparatus of claim 1, wherein the plasma display panel includes a scan electrode, a sustain electrode, and an address electrode.

8. The plasma display apparatus of claim 1, wherein the plasma display panel includes at least one of a scan electrode, a sustain electrode, and an address electrode.

9. The plasma display apparatus of claim 1, wherein the panel driver includes a data driver driving an address electrode, a scan driver driving a scan electrode, and a sustain driver driving a sustain electrode.

10. The plasma display apparatus of claim 1, wherein as the vertical frequency of the video signal increases, the controller increases an average frequency of sustain pulses supplied during a plurality of subfields of one frame.

11. A method of driving a plasma display apparatus, comprising:
storing the number of subfields corresponding to a vertical frequency of a video signal and a sustain pulse frequency proportional to the vertical frequency in a predetermined area and a predetermined mode;
detecting the vertical frequency of the video signal;
selecting an area and a mode corresponding to the detected vertical frequency from a plurality of areas and a plurality of modes which are previously set; and
setting the number of subfields and a sustain pulse frequency corresponding to the selected area and the selected mode.

12. The method of claim 11, wherein the setting of the number of subfields and the sustain pulse frequency includes sending a control signal including the number of subfields and the sustain pulse frequency corresponding to the selected area and the selected mode.

13. The method of claim 11, wherein the sustain pulse frequency in at least one subfield is different from a sustain pulse frequency in the remaining subfields.

14. The method of claim 11, wherein the sustain pulse frequency is two or more in at least one subfield of a frame.

15. The method of claim 11, wherein in the storing of the number of subfields and the sustain pulse frequency, the sustain pulse frequency is linearly set between a minimum value and a maximum value of the vertical frequency.

16. The method of claim 11, wherein as the vertical frequency of the video signal increases, an average frequency of sustain pulses supplied during a plurality of subfields of one frame increases.
